(19) United States
(12) Patent Application Publication
(10) Pub. No.: US 2011/0039059 A1
(43) Pub. Date: Feb. 17, 2011

(54) MOLDING ARTICLE WITH EMI SHIELDING FILM AND METHOD FOR MAKING SAME

(75) Inventor: HSIN-CHIN HUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/756,118

(22) Filed: Apr. 7, 2010

(30) Foreign Application Priority Data
Aug. 12, 2009 (CN) 200910305528.9

(51) Int. Cl. G21F 1/10; B32B 5/12; B29C 45/14

(52) U.S. Cl. 428/114; 523/137; 264/259

(57) ABSTRACT

A molding article includes a base and an EMI shielding film adhered to the base. The base includes a thermoplastic material and is made by injection molding. The EMI shielding film includes carbon nanotubes.

### BACKGROUND

1. Technical Field

The present disclosure relates to molding articles, and particularly to a molding article having an EMI shielding film thereon.

2. Description of Related Art

Electro magnetic interference (EMI) has been a big environment problem for people. Various electronic devices such as mobile phones subject users to EMI.

Metal is known as an EMI shielding material. Currently, more and more shells of electronic devices are covered by metal to provide EMI shielding.

However, the shells are usually molded beforehand, and then coated with metal by some complicated depositing method.

What is needed, therefore, is a molding article with an EMI shielding film and a method for making same, which can overcome the above shortcomings

### BRIEF DESCRIPTION OF THE DRAWINGS

Many aspects of the present molding article and method can be better understood with reference to the following drawings. The components in the drawings are not necessarily drawn to scale, the emphasis instead being placed upon clearly illustrating the principles of the present molding article and method. Moreover, in the drawings, like reference numerals designate corresponding parts throughout the several views.

FIG. 1 is a schematic view of a molding article in accordance with an exemplary embodiment.

FIG. 2 is a flow chart of a method for making the molding article of FIG. 1.

FIG. 3 is a schematic view of the method shown in FIG. 2.

### DETAILED DESCRIPTION OF THE EMBODIMENTS

Embodiments of the present molding article and method will now be described in detail below and with reference to the drawings.

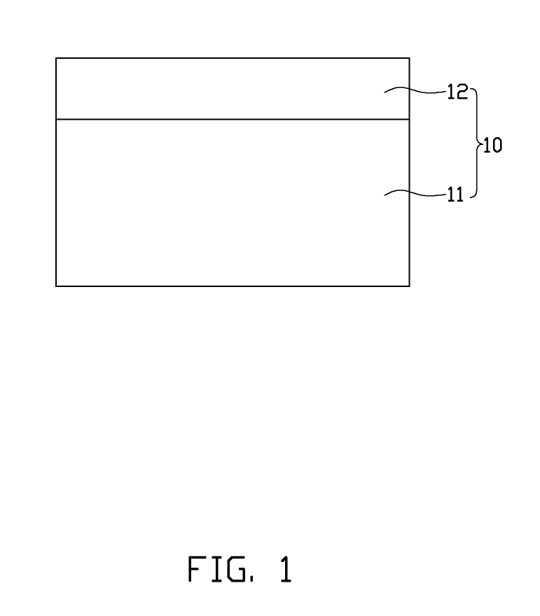

Referring to FIG. 1, a molding article 10 includes a base 11 and an electro magnetic interference (EMI) shielding film 12 adhered to the base 11.

The base 11 is made of or at least includes a thermoplastic material. The base 11 is made by an injection molding method, and can have different shapes according to need.

The EMI shielding film 12 is composed of carbon nanotubes and a polymer matrix. The carbon nanotubes are configured as a major part of the EMI shielding film, and the polymer matrix is configured as a minor part of the EMI shielding film, i.e., a volume of the carbon nanotubes is greater than that of the polymer matrix. In other words, the EMI shielding film 12 is a carbon nanotube-based film. The carbon nanotubes are parallel with each other with central axis thereof along a direction perpendicular to a main surface of the EMI shielding film 12 and perpendicular to a main surface of the base 11 where the EMI shielding film 12 is adhered on. The carbon nanotubes may contain carbon nanotube segments joined end-to-end along the central axis thereof by Van der Waals force. The carbon nanotubes have good electrical conductivity, such that the carbon nanotubes are good at shielding EMI. The polymer matrix is dielectric. The polymer matrix is configured for increasing wettability between the film 12 and the base 11.

The EMI shielding film 12 can be made very thin because of its excellent EMI shielding ability, and thus is transparent to light. The carbon nanotubes can have diameters of about 100 nanometers. The EMI shielding film 12 is transparent, such that colors of the base 11 can are still visible.

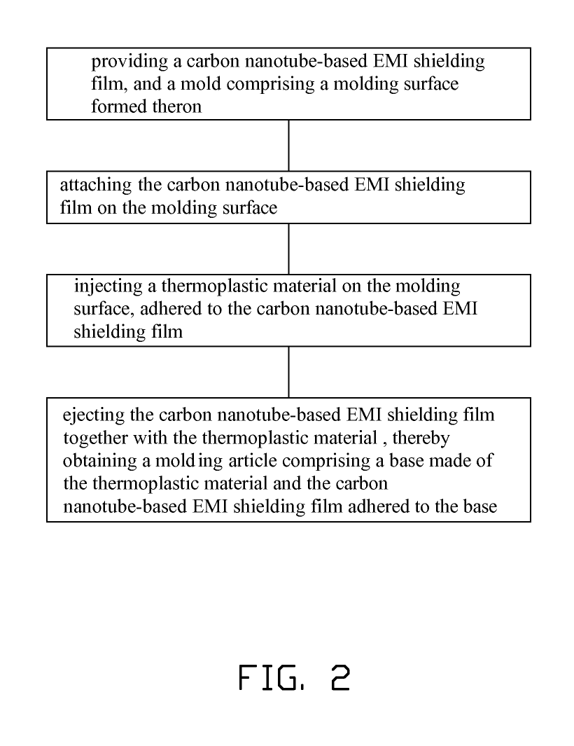

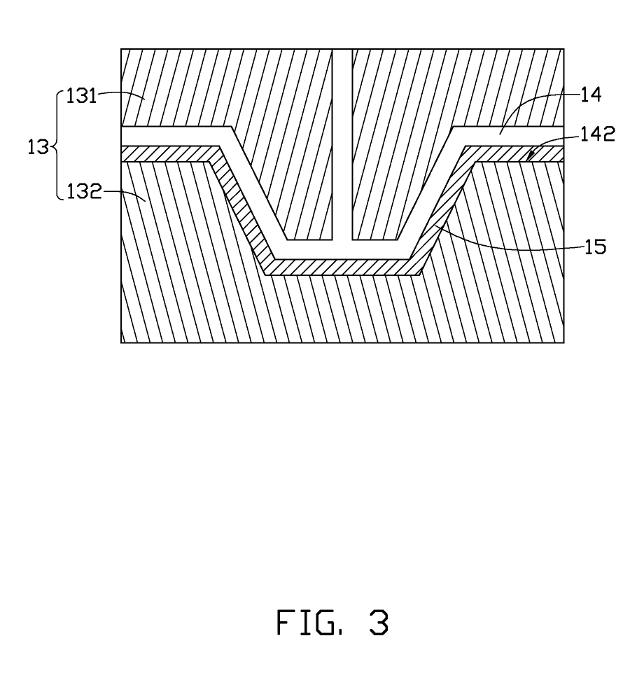

Referring to FIGS. 2 and 3, a method for making the molding article includes the following steps.

First, a preformed carbon nanotube-based electro magnetic interference (EMI) shielding film 15, and a mold 13 including an upper mold 131 and a lower mold 132 are provided. The carbon nanotube-based EMI shielding film 15 is the same as the EMI shielding film 12 detailed above. The upper mold 131 and the lower mold 132 cooperatively define a cavity 14 therein, and the cavity 14 has a molding surface 142 at the lower mold 132. The shape of the cavity 14 can be changed according to need.

Second, the carbon nanotube-based EMI shielding film 15 is attached on the molding surface 142. The carbon nanotube-based EMI shielding film 15 can be attached to the molding surface 142 by a vacuum suction method or by adhesive.

Third, a thermoplastic material (not labeled) is injected in the cavity 14, adhered to the carbon nanotube-based EMI shielding film 12.

Fourth, the carbon nanotube-based EMI shielding film together with the thermoplastic material is ejected, thereby obtaining the molding article including a base made of the thermoplastic material and the carbon nanotube-based EMI shielding film 15 adhered to the base.

In other embodiments, the carbon nanotube-based EMI shielding film 15 is first attached to a flexible substrate, and the flexible substrate is then attached to the molding surface 142. After the base and the carbon nanotube-based EMI shielding film 15 together with the flexible substrate are ejected out from the mold 13, the flexible substrate can be peeled off.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A molding article comprising:
a base and a transparent electro magnetic interference (EMI) shielding film adhered to the base, the base comprising a thermoplastic material and being made by injection molding, the EMI shielding film comprising carbon nanotubes.

2. The molding article as described in claim 1, wherein the EMI shielding film further comprises a polymer matrix with the carbon nanotubes incorporated therein.

3. The molding article as described in claim 2, wherein the polymer matrix is dielectric.

4. The molding article as described in claim 3, wherein a volume of the carbon nanotubes in the EMI shielding film is greater than that of the polymer matrix in the EMI shielding film.

5. The molding article as described in claim 4, wherein the carbon nanotubes are parallel with each other in a direction substantially perpendicular to a main surface of the EMI shielding film.

6. The molding article as described in claim 5, wherein the carbon nanotubes contain carbon nanotube segments joined end-to-end.

7. A molding article comprising:
a base and an EMI shielding film adhered to the base, the base comprising a thermoplastic material and being made by injection molding, the EMI shielding film comprising a dielectric polymer matrix and a plurality of carbon nanotubes dispersed in the polymer matrix.

8. The molding article as described in claim 7, wherein the EMI shielding film is transparent.

9. The molding article as described in claim 7, wherein a volume of the carbon nanotubes in the EMI shielding film is greater than that of the polymer matrix in the EMI shielding film.

10. The molding article as described in claim 7, wherein the carbon nanotubes are parallel with each other in a direction substantially perpendicular to a surface of the EMI shielding film.

11. The molding article as described in claim 10, wherein the carbon nanotubes contain carbon nanotube segments joined end-to-end.

12. A method for making the molding article, comprising:
providing a carbon nanotube-based EMI shielding film, and a mold comprising a molding surface;
attaching the carbon nanotube-based EMI shielding film on the molding surface;
injecting a thermoplastic material on the molding surface, adhered to the carbon nanotube-based EMI shielding film; and
ejecting the carbon nanotube-based EMI shielding film together with the thermoplastic material, thereby obtaining a molding article comprising a base made of the thermoplastic material and the carbon nanotube-based EMI shielding film adhered to the base.

13. The method as described in claim 12, wherein the carbon nanotube-based EMI shielding film comprises a dielectric polymer matrix with the carbon nanotubes dispersed therein.

14. The method as described in claim 12, wherein the carbon nanotube-based EMI shielding film is attached to the molding surface using a vacuum suction method.

15. The method as described in claim 12, wherein the carbon nanotube-based EMI shielding film is attached to the molding surface with adhesive.

16. The method as described in claim 12, wherein the carbon nanotube-based EMI shielding film is attached to a flexible substrate, and the flexible substrate is then attached to the molding surface.
